(19) United States
(12) Patent Application Publication
(10) Pub. No.: US 2025/0151956 A1
(43) Pub. Date: May 15, 2025

(54) Barbeque Oven

(71) Applicant: Positec Power Tools (Suzhou) Co., Ltd, Jiangsu (CN)

(72) Inventors: Graham Gerhardt, Warrandyte (AU); Rui Meng, Suzhou (CN)

(21) Appl. No.: 19/028,223

(22) Filed: Jan. 17, 2025

Related U.S. Application Data
(63) Continuation-in-part of application No. PCT/CN2023/109154, filed on Jul. 25, 2023.

(30) Foreign Application Priority Data
Jul. 26, 2022 (CN) CN202210887032.2

(51) Int. Cl. A47J 37/07

(52) U.S. Cl. CPC A47J 37/0786

(57) ABSTRACT

A barbecue oven includes: a barbecue grill, configured for placing to-be-cooked food; an oven body, including a support surface for supporting the barbecue grill; and a cover, the cover and the oven body arranged movably relative to each other, to form a first state and a second state of the barbecue oven, to form a first state and a second state of the barbecue oven, where in the first state, a first chamber is enclosed by a plane on which the support surface is located and the cover, the first chamber having a first volume, and in the second state, a second chamber is enclosed by a plane on which the support surface is located and the cover, the second chamber having a second volume, wherein the first volume is less than the second volume.

### CROSS-REFERENCE TO RELATED APPLICATIONS

This application is a Continuation-in-part Application of PCT Application No. PCT/CN2023/109154, filed on Jul. 25, 2023, which claims benefit of and priority to Chinese Patent Application No. 202210887032.2, filed on Jul. 26, 2022, all of which are hereby incorporated by reference in their entirety for all purposes as if fully set forth herein.

### TECHNICAL FIELD

This application relates to the field of food cooking device technologies, and in particular, to a barbecue oven.

### BACKGROUND

A barbecue oven is a device used for barbecuing lamb skewers, vegetables, meats, and the like. With the improvement of living standards, using a barbecue oven to barbecue outdoors has become a popular leisure activity for people.

### SUMMARY

This application provides a barbecue oven. In some examples, the barbecue oven includes:
a barbecue grill, configured for placing to-be-cooked food;
an oven body, including a support surface for supporting the barbecue grill; and
a cover, the cover and the oven body arranged movably relative to each other, to form a first state and a second state of the barbecue oven, where in the first state, a first chamber is enclosed by a plane on which the support surface is located and the cover, the first chamber having a first volume, and in the second state, a second chamber is enclosed by a plane on which the support surface is located and the cover, the second chamber having a second volume, where the first volume is less than the second volume.

In a possible embodiment, the first volume is defined as V1, the second volume is defined as V2, and a value of V2/V1 is in a range of 2.4 to 4.8, for example, a value of V2/V1 is in a range of 2.6 to 3.7.

In a possible embodiment, a projection area of the barbecue grill on the plane on which the support surface is located is defined as S1, in the first state, a projection area of the barbecue oven on the plane on which the support surface is located is defined as S2, and a value of S1/S2 is in a range of 0.53 to 0.8, for example, a value of S1/S2 is in a range of 0.53 to 0.63.

In a possible embodiment, a height of the oven body is defined as H1, a height of the barbecue oven in the first state is defined as H2, and a value of H2/H1 is in a range of 1.06 to 1.83, for example, a value of H2/H1 is in a range of 1.2 to 1.4.

In a possible embodiment, the cover operably moves relative to the oven body. In the first state, the cover covers at least a part of an outer contour of the oven body, and in the second state, the cover is unfolded relative to the oven body.

In a possible embodiment, the cover has a first side and a second side opposite to the first side, and the cover is rotatably connected to the oven body on the first side by a rotation shaft.

In a possible embodiment, in a direction perpendicular to the plane on which the support surface is located, a length of the second side is greater than a length of the first side.

In a possible embodiment, the rotation shaft has a rotation axis, and an outer contour of the cover includes: a first arc with the rotation axis as a center when viewed in a direction along the rotation axis; and an outer contour of the oven body includes: a second arc whose center is close to or coinciding with the rotation axis when viewed in the direction along the rotation axis. In a possible embodiment, the cover is slidably connected to the oven body.

In a possible embodiment, the barbecue oven further includes a first locking mechanism, configured to: maintain the barbecue oven in the second state when the cover moves to the second position.

In a possible embodiment, the first locking mechanism includes a first locking member, movably arranged on the cover, wherein when the barbecue oven is in the second state, the first locking member is inserted into a second locking hole provided on the oven body.

In a possible embodiment, the first locking mechanism is configured to: maintain the barbecue oven in the first state when the cover moves to the first position.

In a possible embodiment, the cover includes a housing body and a hood body operably moving relative to the housing body, where the hood body is openable to form a third state of the barbecue oven in which at least a part of the barbecue grill is exposed.

In a possible embodiment, the hood body is rotatably connected to the housing body.

In a possible embodiment, the hood body includes a first end and a second end opposite to the first end, where the first end is configured to be rotatably mounted on the housing body, a handle is arranged at the second end, and the handle is movable relative to the hood body in a direction away from the oven body.

In a possible embodiment, the barbecue oven further includes an upper placement frame for placing food, where the upper placement frame is arranged above the barbecue grill; and/or the upper placement frame includes a main frame and a support arm rotatably connected to the main frame, where the support arm is detachably suspended from the cover.

In a possible embodiment, the barbecue oven further includes:
a support frame, where the support frame includes a guide portion, and the barbecue grill is supported on the support surface by the guide portion; and
a grease drip pan, arranged below the barbecue grill, where
the guide portion is configured to guide grease dripping from an edge of the barbecue grill to the grease drip pan.

In a possible embodiment, the barbecue oven further includes:
a combustion chamber, configured for burning pellet fuel, to provide heat and/or smoke for the second chamber;
a hopper, configured to provide storage space for the pellet fuel;
an auger interposing the hopper and the combustion chamber, and configured to selectively convey the pellet fuel from the hopper to the combustion chamber for combustion;
a fan, configured to blow air into the combustion chamber or allow oxygen to enter the combustion chamber; and
a battery pack, configured to provide power for the auger and/or the fan.

In the first state and/or the second state, at least one of the hopper, the fan, and the battery pack is located outside the second chamber and the combustion chamber.

In a possible embodiment, an outer peripheral wall of the oven body includes a groove, and the battery pack is at least partially arranged in the groove.

In a possible embodiment, the battery pack does not protrude from the groove.

In a possible embodiment, the barbecue oven further includes a battery compartment cover, where the battery compartment cover operably moves relative to the oven body to cover or uncover the battery pack.

In a possible embodiment, when the battery compartment cover covers the battery pack, the battery compartment cover is flush with the outer peripheral wall of the oven body.

In a possible embodiment, the barbecue oven further includes a support leg, where the support leg operably moves relative to the oven body, to support the oven body or to be folded on the oven body.

In a possible embodiment, the hood body includes a first end and a second end opposite to the first end. The first end is configured to be rotatably mounted on the housing body. A second locking mechanism is arranged between the second end and the housing body. When the hood body closes a cooking cavity, the second locking mechanism can lock the hood body at the housing body.

In a possible embodiment, the second locking mechanism includes a second locking member and a second elastic member.

The second locking member is movably arranged on the housing body, and when the hood body closes the cooking cavity, the second locking member can be inserted into a locking hole on the hood body under elastic force of the second elastic member, to lock the hood body at the housing body.

In a possible embodiment, the barbecue oven further includes a handle arranged on the hood body, and an unlocking component is arranged on the handle. When the handle is held and the unlocking component is pressed, a push portion on the unlocking component can push the second locking member out of the locking hole, to unlock the hood body and the housing body.

In a possible embodiment, the handle is configured to be rotatable between a use state and a folded state.

In a possible embodiment, when the handle is rotated to the use state, the push portion corresponds to a part of the second locking member extending out of the locking hole, so that pressing the unlocking component can push the second locking member out of the locking hole.

In a possible embodiment, the barbecue oven further includes a handle arranged on the hood body, the handle includes a handle body and a holding portion arranged on the handle body, and the holding portion is a spiral structure spirally wound on the handle body.

According to the barbecue oven provided in this application, in a non-use state (for example, in a transportation or storage state), the cover is folded on the oven body. During use for barbecue, the cover can be unfolded to form a cooking chamber located above the combustion chamber, and the cover is folded on the oven body after use. Therefore, when the barbecue oven provided in this application is in the non-use state, the overall structure can be compact, small, and portable by folding the cover, and a transportation and storage space can be reduced.

Other features and advantages of this application will be described in detail in the following detailed descriptions.

### BRIEF DESCRIPTION OF THE DRAWINGS

The accompanying drawings constituting a part of this application are used for providing further understanding for this application. Exemplary embodiments of this application and descriptions thereof are used for explaining this application and do not constitute any inappropriate limitation to this application. In the accompanying drawings:

FIG. 1 is a schematic structural diagram of a barbecue oven according to an embodiment of this application (where a barbecue oven is in a first state);

FIG. 2 is a schematic structural diagram of the barbecue oven shown in FIG. 1 (where the barbecue oven is in a second state);

FIG. 3 is an installation diagram of a barbecue grill and a support frame according to an embodiment of this application;

FIG. 4 is a diagram of projections of a barbecue grill and a barbecue oven on a plane on which a support surface is located according to an embodiment of this application;

FIG. 5 is a schematic enlarged view of a part on an oven body of the barbecue oven in FIG. 1 for cooperating with a first locking mechanism;

FIG. 6 is a schematic diagram of a hood body of a barbecue oven opening a cooking chamber according to an embodiment of this application;

FIG. 7 is a schematic structural diagram of the barbecue oven shown in FIG. 6 from another perspective;

FIG. 8 is an enlarged structural view of a rotation shaft joint of the hood body in FIG. 7;

FIG. 9 is a schematic diagram of a hood body of a barbecue oven in an upright state according to an embodiment of this application;

FIG. 10 is a schematic diagram of a hood body detaching from a housing body of a barbecue oven according to an embodiment of this application;

FIG. 11 is a schematic diagram during rotation of a handle of a barbecue oven according to an embodiment of this application;

FIG. 12 is a structural schematic diagram of a handle in a folded state of a barbecue oven according to an embodiment of this application;

FIG. 13 is a schematic structural diagram of the handle in FIG. 12 rotated to a use state;

FIG. 14 is a schematic diagram of opening or closing a hood body by the handle in the use state in FIG. 13;

FIG. 15 is a schematic structural diagram of an upper placement frame according to an embodiment of this application;

FIG. 16 is a schematic structural diagram of a grease drip pan arranged in a barbecue oven according to an embodiment of this application;

FIG. 17 is a structural schematic diagram of a barbecue grill and an upper placement frame arranged in a barbecue oven according to an embodiment of this application;

FIG. 18 is a schematic structural diagram of a grease drip pan according to an embodiment of this application;

FIG. 19 is a schematic diagram of a grease drip collection box arranged below a barbecue oven according to an embodiment of this application;

FIG. 20 is a schematic diagram of a grease drip collection box and an upper placement frame located in a cooking cavity when a cover of a barbecue oven is unfolded according to an embodiment of this application;

FIG. 21 is a schematic diagram of a support leg of a barbecue oven in a folded state according to an embodiment of this application;

FIG. 22 is a schematic diagram of a support leg of a barbecue oven in a folded state according to another embodiment of this application;

FIG. 23 is a schematic structural diagram of a barbecue oven according to another embodiment of this application (where a barbecue oven is in a first state);

FIG. 24 is a schematic structural diagram of the barbecue oven shown in FIG. 23 (where the barbecue oven is in a second state);

FIG. 25 is a schematic diagram of a hood body of a barbecue oven opening a second chamber according to another embodiment of this application;

FIG. 26 is a schematic structural diagram of the barbecue oven shown in FIG. 25 from another perspective;

FIG. 27 is a schematic diagram of a hood body of a barbecue oven in an upright state according to another embodiment of this application;

FIG. 28(a) is an enlarged cross-sectional view of a first locking mechanism in an unlocked state according to another embodiment of this application;

FIG. 28(b) is an enlarged cross-sectional view of a first locking mechanism in a locked state according to another embodiment of this application;

FIG. 29 is a schematic diagram of a handle of a barbecue oven in a state according to an embodiment of this application;

FIG. 30 is a schematic diagram of the handle in FIG. 29 in another state;

FIG. 31 is a schematic diagram of a third state of the barbecue oven in which the handle in FIG. 30 opens a hood body;

FIG. 32 is a partial cross-sectional view of the handle and the hood body when the handle in FIG. 29 is in a folded state;

FIG. 33 is a partial cross-sectional view of the handle and the hood body when the handle in FIG. 30 is in a moved-out state;

FIG. 34 is a schematic diagram of a grease drip collection box arranged below a barbecue oven according to another embodiment of this application;

FIG. 35 is a schematic diagram of taking out the grease drip collection box in FIG. 34;

FIG. 36 is a cross-sectional view of a barbecue oven in a second state according to an embodiment of this application;

FIG. 37 is a top view of a barbecue oven whose components such as a housing body and a barbecue grill are hidden according to another embodiment of this application;

FIG. 38 is a schematic diagram of a closed battery compartment cover of a barbecue oven according to another embodiment of this application;

FIG. 39 is a schematic diagram of an opened battery compartment cover of the barbecue oven in FIG. 38;

FIG. 40 is a schematic diagram of taking out a battery pack from the barbecue oven in FIG. 39 to adapt to a different battery pack;

FIG. 41 is a schematic structural diagram of a barbecue oven according to another embodiment of this application (where a barbecue oven is in a first state);

FIG. 42 is a schematic structural diagram of a barbecue oven according to another embodiment of this application (where a barbecue oven is in a second state);

FIG. 43 is a schematic structural diagram of a barbecue oven according to another embodiment of this application (where a barbecue oven is in a third state); and

FIG. 44 is a schematic diagram of FIG. 43 from another perspective;

FIG. 45 is another schematic structural diagram of an example barbecue oven of this application, wherein (a) the barbecue oven is in the first state, (b) the barbecue oven is in the middle state, and (c) the barbecue oven is in the second state;

FIG. 46 is another schematic structural diagram of an example barbecue oven of this application, wherein (a) the barbecue oven is in the first state, (b) the barbecue oven is in the second state;

FIG. 47 is another schematic structural diagram of an example barbecue oven of this application, wherein (a) the barbecue oven is in the second state, (b) the barbecue oven is in the middle state, and (c) the barbecue oven is in the first state;

FIG. 48 is another schematic structural diagram of an example barbecue oven of this application, wherein (a) the barbecue oven is in the first state, (b) the barbecue oven is in the second state;

FIG. 49 is another schematic structural diagram of an example barbecue oven of this application, wherein (a) the barbecue oven is in the second state, (b) the barbecue oven is in the middle state, and (c) the barbecue oven is in the first state;

FIG. 50 is another schematic structural diagram of an example barbecue oven of this application, wherein (a) the barbecue oven is in the second state, (b) the barbecue oven is in the middle state, and (c) the barbecue oven is in the first state.

### DETAILED DESCRIPTION

The technical solutions in embodiments of this application are clearly and completely described in the following with reference to the accompanying drawings in the embodiments of this application. The described embodiments are merely some rather than all of the embodiments of this application. All other embodiments obtained by a person of ordinary skill in the art based on the embodiments of this application without creative efforts shall fall within the protection scope of this application. Embodiments in this application and features in the embodiments may be combined with each other in the case of no conflict.

In the descriptions of this application, it should be understood that orientation or position relationships indicated by terms such as “center”, “longitudinal”, “transverse”, “above”, “below”, “left”, “right”, “vertical”, “horizontal”, “top”, “bottom”, “axial”, “radial”, and “circumferential” are based on orientation or position relationships shown in the accompanying drawings, and are used only for ease and brevity of illustration and description, rather than indicating or implying that the mentioned apparatus or component needs to have a particular orientation or needs to be constructed and operated in a particular orientation. Therefore, such terms should not be construed as limiting to this application. In addition, “inside and outside” refer to inside and outside of contours of components.

In addition, terms “first” and “second” are used merely for the purpose of description, and shall not be construed as indicating or implying relative importance or implying a quantity of indicated technical features. Therefore, a feature restricted by “first” or “second” may explicitly indicate or implicitly include at least one of such features.

A barbecue oven includes a combustion chamber configured to accommodating fuel for burning. When the barbecue oven is used for a barbecue operation, heat in the combustion chamber flows upward to a barbecue grill above, to heat food on the barbecue grill. To reduce heat dissipation above the barbecue grill, a cooking chamber is arranged above the combustion chamber (to be specific, a space enclosed by the cover is arranged above the combustion chamber), and the heat in the combustion chamber can move upward into the cooking chamber, to increase a temperature in the cooking chamber. This helps to increase a speed of fully cooking food.

Arrangement of the cooking chamber in the barbecue oven makes a larger volume of the barbecue oven. To resolve a problem of a large volume and poor portability of the barbecue oven, some embodiments of this application provide a barbecue oven 100.

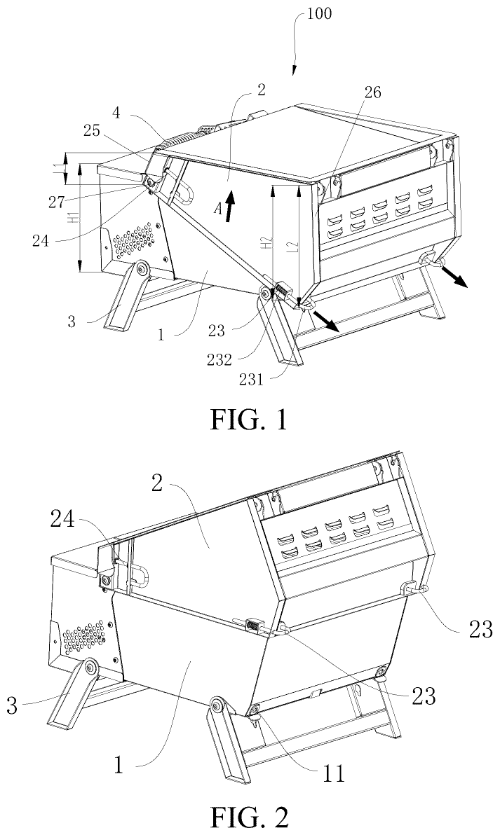

As shown in FIG. 1 to FIG. 3, the barbecue oven 100 includes:
a barbecue grill 6, configured for placing to-be-cooked food;
an oven body 1, including a support surface 18 for supporting the barbecue grill 6, where the support surface 18 directly supports the barbecue grill 6 in some embodiments, or indirectly supports the barbecue grill 6 by an intermediate member; and
a cover 2, arranged movably relative to the oven body 1 covering the barbecue grill 6, to form a first state and a second state of the barbecue oven 100, where in the first state (a state as shown in FIG. 1), the barbecue oven 100 is in a non-use state, and a plane 180 on which the support surface 18 is located and the cover 2 enclose a first chamber having a first volume; and in the second state (a state shown in FIG. 2), the barbecue oven 100 is in a use state, the plane 180 on which the support surface 18 is located and the cover 2 enclose a second chamber having a second volume, where the first volume is smaller than the second volume.

In the barbecue oven 100 provided in this application, the cover 2 is configured to be foldable. In the first state, the cover 2 can be folded on the oven body 1. In this case, the cover 2 covers the barbecue grill 6, to prevent dust from entering the barbecue oven, and prevent an interior of the barbecue oven from rusting and generating dust, facilitating transportation and storage. During use for barbecue, the cover 2 can be unfolded to form the cooking chamber above the combustion chamber. Barbecuing in the cooking chamber can reduce heat dissipation during barbecue, conducive to increasing a barbecue speed.

Therefore, in the non-use state, by folding the cover 2, the barbecue oven 100 provided in this application can have a compact and small overall structure and good portability, and save transportation and storage space.

In the use state, the cover 2 is unfolded relative to the oven body 1, the cover 2 encloses and covers the barbecue grill 6, to form the second chamber. The second chamber is understood as the cooking chamber in some embodiments, so that there is enough space to place to-be-cooked food above the barbecue grill 6.

In some embodiments, the first volume is defined as V1, and the second volume is defined as V2. Based on types of the barbecue ovens, for example, a portable type, a medium type, and a large type, for values of the first volume VI and the second volume V2, refer to Table 1. The types of the barbecue ovens herein are distinguished based on application scenarios and barbecue objects.

TABLE 1

| V1 (in.³) | V2 (in.³) | V2/V1 |
|---|---|---|
| 385.50 | 1165.61 | 3.02 |
| 207.77 | 979.70 | 4.72 |
| 552.48 | 1343.01 | 2.43 |
| 295.01 | 1074.79 | 3.64 |
| 469.26 | 1254.61 | 2.67 |

A value of a ratio V2/V1 of the second volume V2 to the first volume V1 is in a range of 2.4 to 4.8, in some embodiments, a value of V2/V1 is in a range of 2.6 to 3.7, for example, the value of V2/V1 is 3.02. In this way, compared with the second state, a volume above the barbecue grill in the barbecue oven in the first state is apparently smaller, and in the non-use state, the barbecue oven is easier to be stored and transported. If the value of V2/V1 is excessively small, a change between the volume in the use state and the volume in the non-use state is not apparent, and compact storage cannot be achieved. If the value of V2/V1 is excessively large, a manner is that the first volume V1 is small enough, but embodiments are limited, and it is hardly for V1 to be infinitely small; and another manner is that the second volume V2 is large enough, and in this case, an overall volume of the barbecue oven is to be increased infinitely.

In some embodiments, as shown in FIG. 4, a projection area of the barbecue grill 6 on the plane on which the support surface is located is defined as S1. In the first state, a projection area of the barbecue oven 100 on the plane 180 on which the support surface is located is defined as S2. Different types of barbecue ovens are distinguished. Generally, a cooking area of the portable barbecue oven ranges from 100 in.² to 300 in.², a cooking area of the medium barbecue oven ranges from 300 in.² to 500 in.², and a cooking area of the large barbecue oven is more than 500 in.^{2.} The cooking area herein is a total area of a barbecue grill including two layers or of a barbecue grill including three or more layers in some embodiments. For values of the projection area S1 of the barbecue grill 6 on the plane on which the support surface is located, the projection area S2 of the barbecue oven on the plane 180 on which the support surface is located in the first state, and the overall volume V of the barbecue oven, refer to Table 2. S1 is a projection area of a largest single layer of the barbecue grill or a projection area of a barbecue grill of multiple layers after projection.

TABLE 2

| S1 | S2 | Volume V (in.³) of | | S1/V | S2/V |
|---|---|---|---|---|---|
| (in.²) | (in.²) | a barbecue oven | S1/S2 | (in.⁻¹) | (in.⁻¹) |
| 191 | 460 | 7250 | 0.42 | 0.026 | 0.06 |
| 184 | 353 | 4450 | 0.52 | 0.041 | 0.08 |
| 192 | 354 | 3374 | 0.54 | 0.057 | 0.10 |
| 300 | 522 | 6167 | 0.57 | 0.049 | 0.08 |
| 500 | 796 | 10969 | 0.63 | 0.046 | 0.07 |

The value of the ratio S1/S2 of the projection area SI of the barbecue grill 6 on the plane on which the support surface is located to the projection area S2 of the barbecue oven on the plane 180 on which the support surface is located is in a range of 0.53 to 0.8, in some embodiments, a value of S1/S2 is in a range of 0.53≤S1/S2≤0.63, for example, the value of S1/S2 is 0.54. In this way, when the barbecue oven is normally placed, from a top view, the barbecue grill 6 occupies a most part of an area of the whole barbecue oven. That is, an effective area for barbecue is large.

A value of the ratio S1/V of the projection area S1 of the barbecue grill 6 on the plane on which the support surface is located to the volume V of the barbecue oven is in a range of 0.045 to 0.066, in some embodiments, A value of S1/V is in a range of 0.045 to 0.057, for example, the value of S1/V is 0.057. A value of the ratio S2/V of the projection area S2 of the barbecue oven on the plane 180 on which the support surface is located to the volume V of the barbecue oven is in a range of 0.08 to 0.12, in some embodiments, a value of S2/V is in a range of 0.08 to 0.1, for example, the value of S2/V is 0.10. In this way, a height of the barbecue oven is in a limited range, and a layout of the barbecue oven is more proper and compact.

In some embodiments, as shown in FIG. 1, a height of the oven body 1 is defined as H1, the height of the barbecue oven in the first state is H2. For values of the heights H1 of different types of oven bodies 1 of the barbecue ovens and the heights H2 of the barbecue ovens in the first state, refer to Table 3.

TABLE 3

| H1 (in) | H2 (in) | H2/H1 |
|---|---|---|
| 7.52 | 9.53 | 1.27 |
| 7.52 | 9.06 | 1.20 |
| 7.52 | 13.78 | 1.83 |
| 12.99 | 13.78 | 1.06 |
| 9.84 | 13.78 | 1.40 |

A value of the ratio H2/H1 of the height H2 of the barbecue oven 100 in the first state to the height H1 of the oven body 1 is in a range of 1.06≤H2/H1≤1.83, in some embodiments, a value of H2/H1 is in a range of 1.2 to 1.4, for example, the value of H2/H1 is 1.27. It can be seen that, relative to the oven body 1, an overall height of the barbecue oven in the first state is small. In other words, in a storage state, a height of a space above the oven body 1 is relatively small.

In some embodiments, in the first state, the cover 2 at least partially covers the oven body 1, or the cover 2 is at least partially folded on the oven body 1, to form the first chamber. In the second state, the cover 2 is unfolded relative to the oven body 1, to form the second chamber.

In some embodiments, the cover 2 has a first side 25 and a second side 26 opposite to the first side 25. The cover 2 is rotatably connected to the oven body 1 by a rotation shaft 27 on the first side 25, and the cover 2 is rotated relative to the oven body 1 through the rotation shaft 27, to implement switch between the first state and the second state.

In some embodiments, as shown in FIG. 1, in a direction A perpendicular to the plane 180 on which the support surface 18 is located, a length L2 of the second side 26 is greater than a length L1 of the first side 25.

As shown in FIG. 1 and FIG. 2, a front end of a part of the cover 2 close to a front side of the barbecue oven 100 is rotatably connected to the oven body 1, and the cover 2 causes a rear end to move upward through rotation, to switch from the first state to the second state.

The “front” and “rear” in this application are described relative to the use state of the barbecue oven, during barbecue operation, a position at which a user is barbecuing is “front”, and the opposite other side of the barbecue oven is “rear”.

In this embodiment, a height of the rear end of the cover 2 is higher than a height of the front end. In this way, when the rear end is rotated upward to the first state, the cover 2 forms a cooking cavity whose rear end is higher than the front end. When the rear end is rotated downward to the second state, the rear end having the higher height is folded on the oven body, so that a volume can be greatly reduced.

To maintain the cover 2 in the first position and the second position, a first locking mechanism 23 is arranged between the cover 2 and the oven body 1, and the first locking mechanism 23 is configured to maintain the barbecue oven 100 in the second state when the cover 2 is rotated to the second position.

In some embodiments, as shown in FIG. 1 and FIG. 2, the first locking mechanism 23 includes a first locking member 231, the first locking member 231 is movably arranged on the cover 2, and when the cover 2 is in the second position, the first locking member 231 is inserted into a second locking hole (not shown due to blocking by the cover 2) provided on the oven body 1.

Further, the first locking mechanism 23 is also configured to maintain the barbecue oven 100 in the first state when the cover 2 is rotated to the first position.

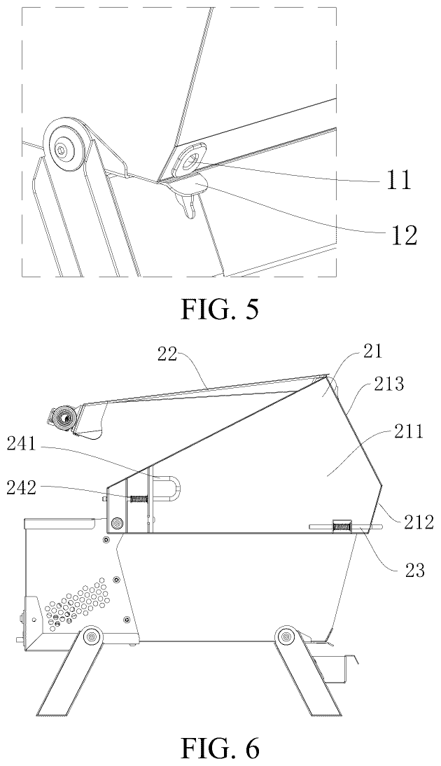

The first locking mechanism 23 further includes a first elastic member 232. When the cover 2 is in the first position, under action of the first elastic member 232, the first locking member 231 can be inserted into a first locking hole 11 (referring to FIG. 5) provided on the oven body 1, to maintain the cover 2 in the first position. When the cover 2 is in the second position, under action of the first elastic member 232, the first locking member is inserted into the second locking hole (not shown due to blocking by the cover 2) provided on the oven body 1, to maintain the cover 2 in the second position. The first elastic member is not arranged in the first locking mechanism 23 in some embodiments, and the cover 2 is fixed separately in the first position and the second position by manually operating a buckle, a screw, or a pin, or in another form.

In some embodiments, a limiting portion 12 is arranged on the oven body 1. As shown in FIG. 5, when rotating from the second position to the first position, the cover 2 is limited by the limiting portion 12. In this case, the first locking member 231 can directly face and be inserted into the first locking hole 11.

In some embodiments, the cover 2 includes a housing body 21 and a hood body 22 operably moving relative to the housing body 21. The hood body 22 is configured to open and close the cooking cavity. During barbecue operation, the hood body 22 is used to open the cooking cavity, to form a third state of the barbecue oven in which the barbecue grill 6 is at least partially exposed. In this case, to-be-cooked food can be placed, or barbecued food can be taken out. Closing the cooking cavity can help increase a cooking speed for food being barbecued.

In some embodiments, the hood body 22 is rotatably connected to the housing body 21, to open and close the cooking cavity.

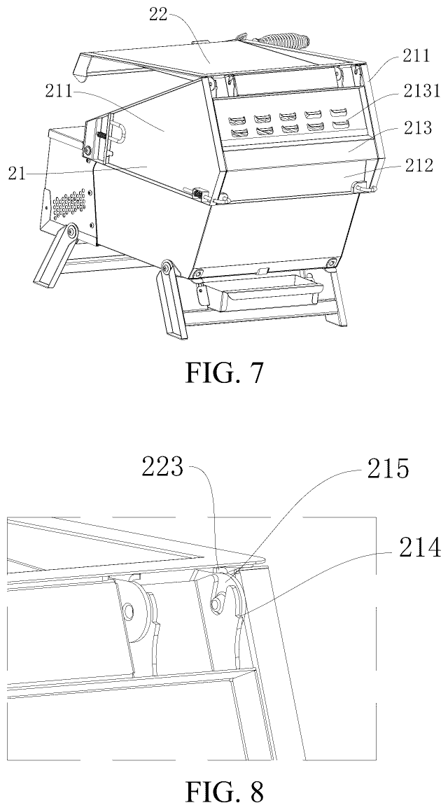

In embodiments shown in FIG. 6 and FIG. 7, two side plates 211 and an end plate connected at a rear end of the two side plates 211 are arranged between the first side 25 and the second side 26 of the housing body 21. The hood body 22 is configured to be rotatably connected to the end plate at the rear end, to open and close the cooking cavity enclosed by the side plates and the end plate.

The side plates 211 located on the two sides have a part whose height increases from front to rear, and front ends of the side plates 211 on the two sides are rotatably connected to the oven body 1 separately.

In this embodiment, the side plates 211 are configured with the part whose height increases from front to rear. When the rear end of the cover 2 is rotated upward to the second position, the rear end of the cover 2 rises, forming the cooking chamber, and a rear side of the cover 2 is configured to be high and gradually lower in a direction toward the front side. This is convenient for a barbecue operation.

As shown in FIG. 7, the end plate includes a first end plate 212 and a second end plate 213 arranged up and down, where the second end plate 213 located above is more inclined forward than the first end plate 212. A smoke discharging hole 2131 is provided on the cover 2, in some embodiments, the smoke discharging hole 2131 is provided on the end plate. The smoke discharging hole 2131 herein is provided on the second end plate 213, and smoke in the cooking chamber can be discharged from the smoke discharging hole 2131.

In some embodiments, the rear end of the hood body 22 is configured to be rotatably mounted on the housing body 21, and the hood body 22 is configured to be rotatable to an upright state and remain in the upright state.

As shown in FIG. 7 to FIG. 9, the rear end of the hood body 22 is rotatably mounted at the rear end of the housing body 21 by the rotation shaft. A support portion 214 is arranged at the rear end of the housing body 21, and a cooperating portion 223 is arranged at the rear end of the hood body 22. When the cooking chamber is opened, the hood body 22 is rotated backward until the cooperating portion 223 is supported on the support portion 214. In this case, the hood body 22 can remain in the upright state, and does not need another object for support. Operation is simple and convenient. When the hood body 22 is required for closing the cooking chamber, the hood body 22 is only needed to be directly rotated downward.

In some embodiments, the hood body 22 is configured to be detachable from the housing body 21. As shown in FIG. 10 (referring to FIG. 8), a rotation shaft groove 215 is provided at the rear end of the housing body 21. The rotation shaft of the hood body 22 is rotatably mounted on the rotation shaft groove 215, and the rotation shaft can detach from the rotation shaft groove 215 from a groove opening of the rotation shaft groove 215, so that the hood body 22 can detach from the housing body 21. The hood body 22 detaching from the housing body 21 is convenient for cleaning.

A second locking mechanism 24 is arranged between the front end of the hood body 22 and the housing body 21 in some embodiments. When the hood body 22 closes the cooking cavity, the second locking mechanism 24 can lock the hood body 22 at the housing body 21.

In some embodiments, as shown in FIG. 6 and FIG. 12, the second locking mechanism 24 includes a second locking member 241 and a second elastic member 242. The second locking member 241 is movably arranged on the housing body 21, and when the hood body 22 closes the cooking cavity, the second locking member 241 can be inserted into a locking hole 221 on the hood body 22 under elastic force of the second elastic member 242, to lock the hood body 22 at the housing body 21.

Due to a high temperature of the hood body 22 during barbecue, there is a risk of being scalded in manually opening the hood body 22. To conveniently open the hood body 22, the barbecue oven 100 further includes a handle 4 arranged on the hood body 22, and the hood body 22 is opened by using the handle 4.

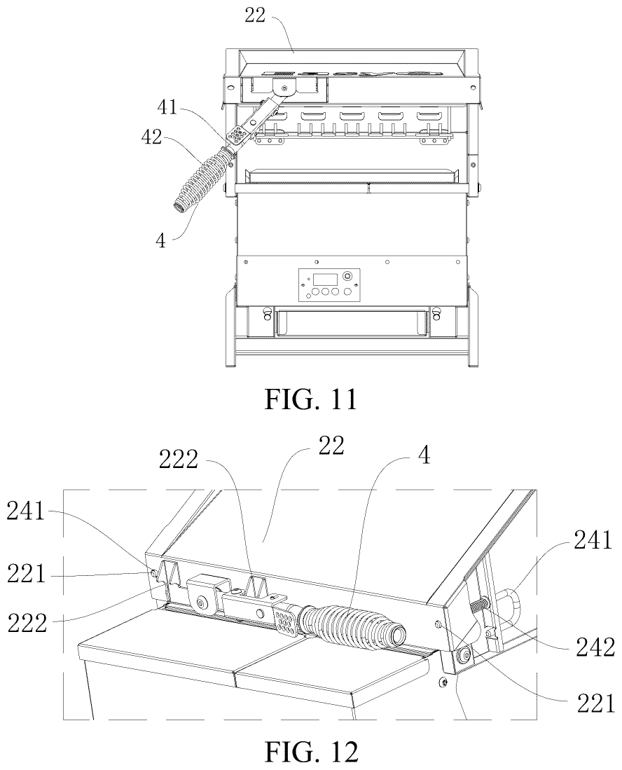

In a possible embodiment, as shown in FIG. 11, the handle 4 includes a handle body 41 and a holding portion 42 arranged on the handle body 41, and the holding portion 42 is a spiral structure spirally wound on the handle body 41.

In some embodiments, a radial size of the spiral structure is configured to gradually increase from two ends of the holding portion 42 to a middle part in some embodiments. In this way, the spiral structure has a good hand feel, and a gap is formed between the holding portion 42 of the spiral structure and the handle body 41, so that an anti-scald effect is achieved, and a user is prevented from being hurt by a high temperature.

In addition, the holding portion 42 of the spiral structure is rotatable relative to the handle body 41. Therefore, when the holding portion 42 is held by a hand, the spiral structure is rotatable relative to the handle body 41, and is fixed relative to the hand, so that the hand does not need to rotate with rotation of the hood body 22.

When the hood body 22 closes the cooking cavity, as shown in FIG. 12, the second locking member 241 is inserted into the locking hole 221 of the hood body 22 under the elastic force of the second elastic member 242. In this case, the hood body 22 is in a locked state. However, there is also a risk of scald in unlocking the hood body 22. To conveniently unlock the hood body 22, in a possible embodiment, the handle 4 is used to unlock the hood body 22.

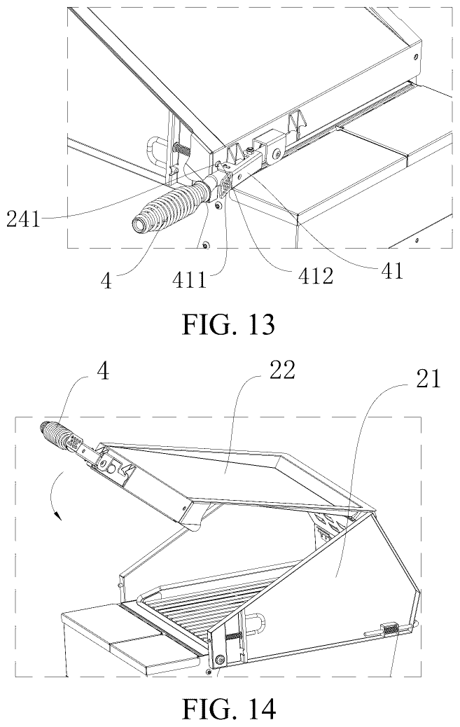

As shown in FIG. 13, an unlocking component 41 is arranged on the handle 4. When the handle 4 is gripped by a hand, to unlock a press portion 411 of the unlocking component 41, a push portion 412 on the unlocking component 41 can push the second locking member 241 out of the locking hole 221, to unlock the hood body 22 from the housing body 21.

FIG. 14 shows a state in which an unlocked hood body 22 is lifted by using the handle 4, to open the cooking cavity, and the handle 4 drives the hood body 22 to rotate downward to close the cooking cavity.

In some embodiments, the handle 4 is configured to be rotatable between a use state and a folded state. When the handle 4 is rotated to the use state, the push portion 412 corresponds to a part of the second locking member 241 extending out of the locking hole 221, so that pressing the unlocking component 41 can push the second locking member 241 out of the locking hole 221.

FIG. 12 shows that when the handle 4 is in the folded state, and the barbecue oven 100 is in the non-use state, the hood body 22 is locked at the housing body 21, and the handle 4 is rotated to the folded state. This is conducive to structure compactness. FIG. 11 shows a state in which the handle 4 is rotated from the folded state to the use state. FIG. 13 and FIG. 14 show that the handle 4 is rotated to the use state.

Further, the handle 4 is connected to the hood body 22 by the rotation shaft, and a handle remaining portion 222 is arranged on each of two sides of the rotation shaft. As shown in FIG. 12, when the handle 4 is in the folded state, the handle 4 remains on the handle remaining portion 222 on a right side. As shown in FIG. 14, when the handle 4 is in the use state, the handle 4 remains on the handle remaining portion 222 on a left side. It can be understood that the hood body 22 is not limited to opening and closing the cooking cavity through rotation, for example, the hood body 22 is configured to be movable in some embodiments. To be specific, the hood body 22 opens the cooking cavity when being moved backward to a specific position, and closes the cooking cavity when being moved forward to a specific position.

In some embodiments, the barbecue oven 100 further includes an upper placement frame 5. The barbecue grill 6 is arranged at a position above the oven body 1, and the upper placement frame 5 is arranged above the barbecue grill 6 at an interval. The barbecue grill 6 is used to barbecue food. The upper placement frame 5 can be used to place barbecued food or to-be-barbecued food. In the second state, the second chamber of the barbecue oven 100 can accommodate the upper placement frame 5, and effectively utilize space for barbecue.

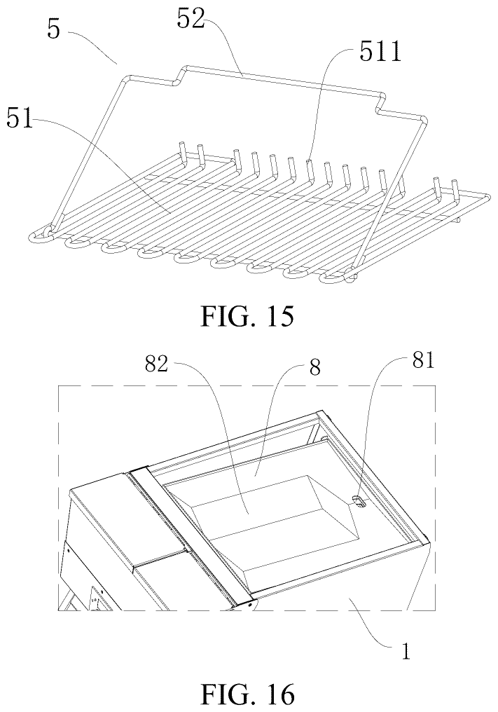

In some embodiments, as shown in FIG. 15, the upper placement frame 5 includes a main frame 51 and a support arm 52 rotatably connected to the main frame 51, and the support arm 52 is configured to be detachably suspended from the cover 2. To prevent rotation of the hood body 22 from affecting the support arm 52, the support arm 52 is suspended from the housing body 21.

A rear end of the upper placement frame 5 abuts against the end plate at the rear end of the cover 2, and a bent portion 511 bent upward is arranged at the rear end of the upper placement frame 5. The bent portion 511 can prevent food from rolling off the rear end.

Because during barbecuing food, grease drips from the food on the barbecue grill 6, as shown in FIG. 16, the barbecue oven 100 further includes a grease drip pan 8. The grease drip pan 8 is arranged below the barbecue grill 6, and is configured to receive the grease dripping from the food on the barbecue grill 6.

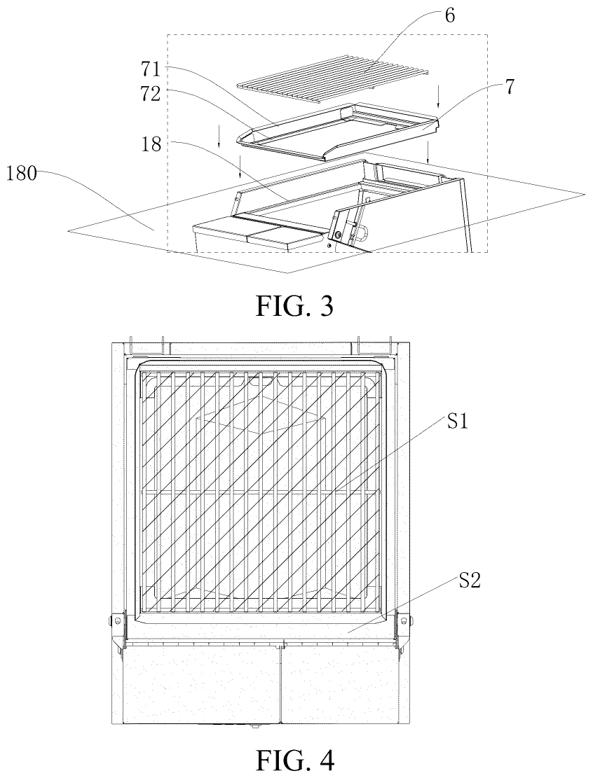

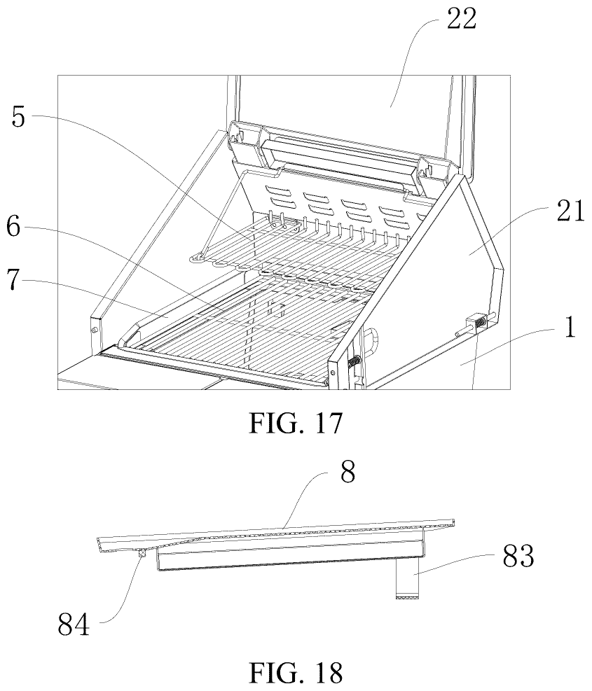

A gap exists between an edge of the barbecue grill 6 and the grease drip pan 8, to cause heat and smoke to flow in the gap and to rise from the gap to the food. However, a problem of providing a gap is that grease dripping from the edge of the barbecue grill 6 drips from the gap. To resolve the problem, in a possible embodiment, as shown in FIG. 17 and FIG. 3, the barbecue oven 100 includes: a support frame 7. The support frame 7 is mounted on the oven body 1, and the edge of the barbecue grill 6 is supported on the support frame 7. The support frame 7 includes a block 71 extending upward and arranged around the edge of the barbecue grill 6 and a guide portion 72 extending inward and downward from the block 71. The guide portion 72 is configured to guide the grease dripping from the edge of the barbecue grill 6 to fall to the grease drip pan 8.

In some embodiments, for a structure of the grease drip pan 8, refer to FIG. 16 and FIG. 18. A recess portion 82 recessing downward is arranged at a middle position of the grease drip pan 8, so that a flame in the combustion chamber below can spread along a lower surface of the grease drip pan 8 for heating. A front bracket 83 close to a front end and a positioning portion 84 close to a rear end are further arranged below the grease drip pan 8. The positioning portion 84 is configured to position the grease drip pan at a suitable position. The front bracket 83 is supported on a structure (for example, on an air box) surrounding the combustion chamber in some embodiments, thereby supporting the grease drip pan 8.

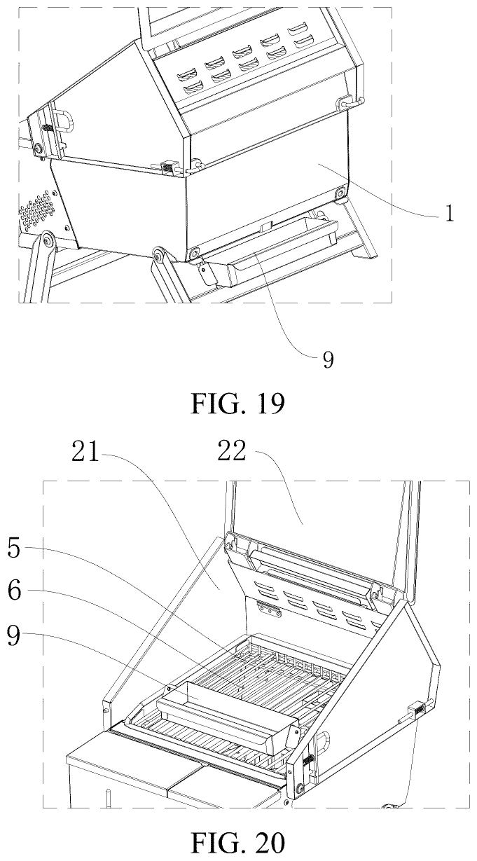

A grease drip hole 81 is provided at a position at the rear end of the grease drip pan 8, and an upper surface surrounding the recessed portion 82 in the middle is gradually inclined downward in a front-to-rear direction, so that grease dripping onto the grease drip pan 8 can flow into the grease drip hole 81 along the inclined surface, and then flow from the grease drip hole 81 to a grease drip collection box 9 arranged below (referring to FIG. 19).

It can be understood that the structure of the grease drip pan 8 is not limited to the structure described above, and other types of structures are used in some embodiments, provided that the grease drips dripping from the barbecue grill 6 can be accommodated.

Both the drip collection box 9 and the upper placement frame 5 can be placed in the cooking cavity in the non-use state. When the cover 2 is in a folded state, there is a space between the cover 2 and the barbecue grill 6, and the drip collection box 9 and the upper placement frame 5 can be placed in the space after being detached. FIG. 20 shows a state in which the drip collection box 9 and the upper placement frame 5 are located in the cooking cavity when the cover 2 is unfolded from the first position to the second position. After the upper placement frame 5 is detached from the cover 2, the support arm 52 is rotated to a folded state and placed on the barbecue grill 6.

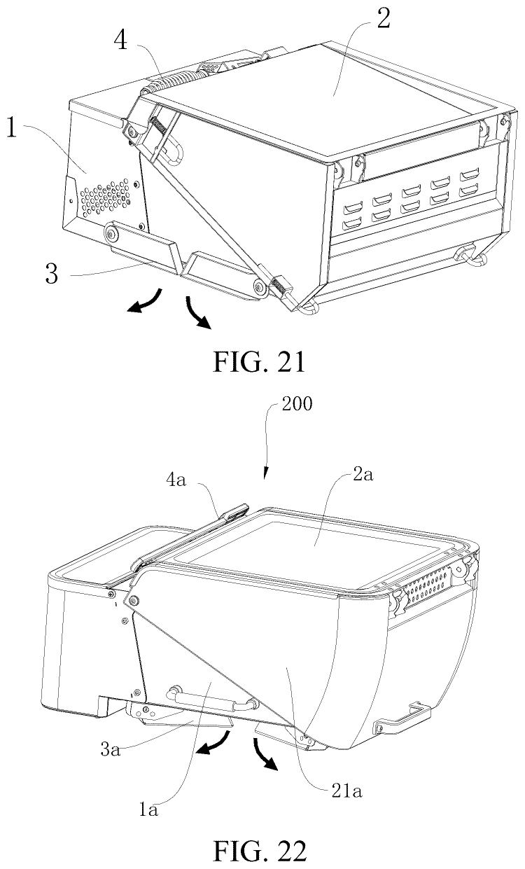

In some embodiments, the barbecue oven 100 further includes a support leg 3, where the support leg 3 operably moves relative to the oven body 1, to support the oven body 1 or to be folded on the oven body 1. During transportation or storage, the support leg 3 is foldable (in a state shown in FIG. 21), so that the barbecue oven has a compact structure and a small volume. During use, the support leg 3 is unfolded, so that a gap is provided between the oven body of the barbecue oven including the combustion chamber and the ground or a desktop supporting the barbecue oven, and the support leg 3 can be folded and unfolded in a form of rotating or sliding relative to the oven body.

In some embodiments, a auger configured to convey the fuel into the combustion chamber, an igniter configured to ignite the fuel, a fan configured to provide air power for the combustion chamber and a hopper for storing fuel are further arranged on the oven body 1, and a battery pack configured to provide electricity and a controller are further arranged on the oven body 1. The battery pack is a rechargeable battery, and can supply power to the auger, the fan, and the igniter. At least one of the hopper, the fan, and the battery pack is located outside the second chamber and the combustion chamber. In some embodiments, a manner in which the auger, the fan, the battery pack, the controller, and the like are arranged on the oven body is not limited, and is not described in detail herein.

The fuel used in the barbecue oven is pellet fuel in some embodiments. The pellet fuel is heating fuel made by compressing biomass, and the most common type is wood particles. As a form of wood fuel, wood particles are usually made of compacted sawdust generated by sawing wood and other wood products, or other waste, which has high burning efficiency and a long burning time.

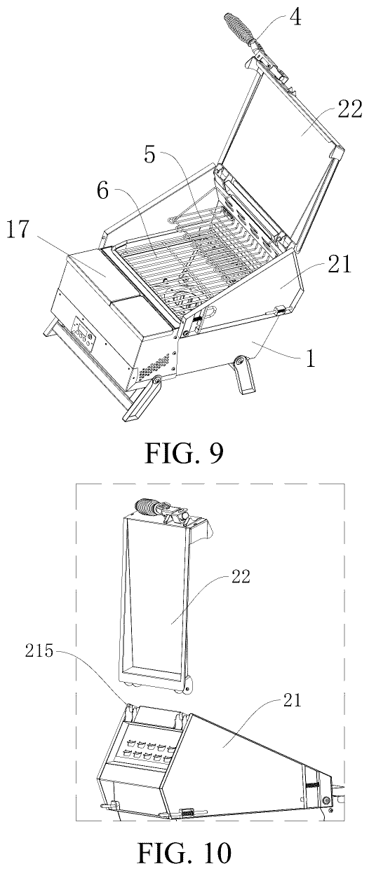

In some embodiments, a cover plate 17 is further arranged above the hopper and the fan of the barbecue oven 100. The cover plate 17 and the oven body 1 are movably arranged, and are switchable between an open position and a closed position. When the cover plate 17 is opened, the pellet fuel can be placed into the hopper. As shown in FIG. 9, the cover plate 17 is two pieces that are opened respectively to expose one of the hopper and the fan in some embodiments. In FIG. 9, only the cover plate above the hopper is opened, and the cover plate above the fan is fixedly connected to the oven body 1 in some other embodiments.

In some other embodiments, FIG. 22 to FIG. 27 show a barbecue oven 200 from a state in which a support leg 3a and a cover 2a are folded on an oven body 1a, to a state in which the support leg 3a is unfolded, the cover 2a is unfolded, and a hood body 22a is opened, until the hood body 22a remains in an upright state relative to the oven body 1a. The upright state herein is perpendicular to a plane on which the support surface is located in some embodiments, or is an inclined state greater than 90 degrees in some other embodiments.

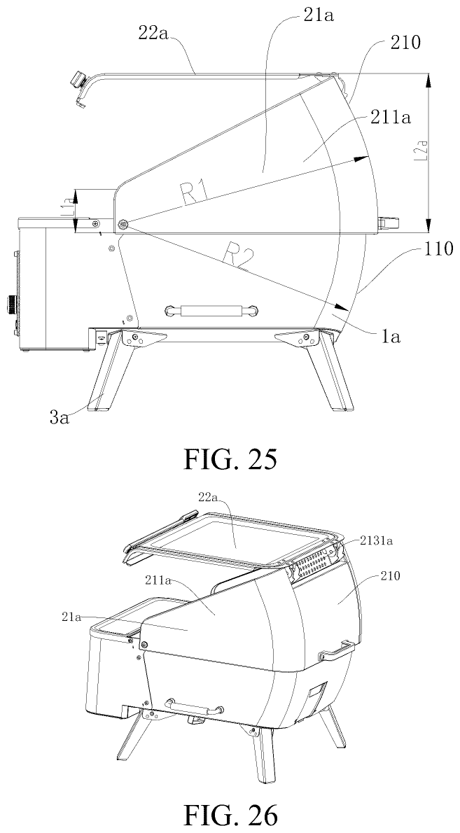

In some embodiments, as shown in FIG. 25, the cover 2a has a first side 25a and a second side 26a opposite to the first side 25a. The cover 2a is rotatably connected to the oven body 1a by a rotation shaft 27a on the first side 25a. The rotation shaft 27a of the cover 2a has a rotation axis. An outer contour of the cover 2a includes: a first arc R1 with the rotation axis as a center when viewed in a direction along the rotation axis. An outer contour 110 of the oven body 1a includes: a second arc R2 whose center is close to or coinciding with the rotation axis when viewed in the direction along the rotation axis. In other words, the barbecue oven 200 is projected to a plane perpendicular to the rotation axis of the rotation shaft 27a, the outer contour of the cover 2a and the outer contour of the oven body 1a are circular arc segments. In some embodiments, the cover 2a includes an end plate 210 at a position close to the second side 26a, the first arc R1 is a projection of the end plate 210 on the plane perpendicular to the rotation axis of the rotation shaft 27a, and the second arc R2 is a projection of the outer contour 110 of the oven body 1a close to the second side 26a on the plane perpendicular to the rotation axis of the rotation shaft 27a. Centers of the first arc R1 and the second arc R2 are close, where close herein means that a distance between the two centers is in a range of 10 mm in some embodiments. In some embodiments, the two centers coincide with each other. In this way, the outer contour of the cover 2a and the outer contour 110 of the oven body 1a have the same or similar positions of the centers. In the first state, the cover 2a and the outer contour of the oven body 1a can be maintained at a short distance and at a fixed position. In the second state, the cover 2a can be unfolded relative to the oven body 1a, and is completely formed above the oven body 1a, to enclose the second chamber, so that space utilization is maximized, and the barbecue oven is aesthetically pleasant in appearance.

In some embodiments, as shown in FIG. 26, two side plates 211a and an end plate 210 connected to rear ends of the two side plates 211a are arranged between the first side 25a and the second side 26a of the housing body 21a, and a smoke discharging hole 2131a is provided on the cover 2a. In some embodiments, the smoke discharging hole 2131a is provided on the end plate 210, and smoke in the cooking chamber can be discharged from the smoke discharging hole 2131a.

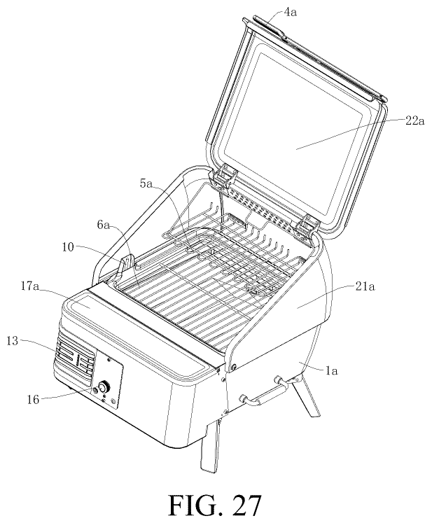

In some embodiments, as shown in FIG. 27, the barbecue oven 200 further includes a barbecue grill 6a and an upper placement frame 5a. The barbecue grill 6a is arranged at a position above the oven body 1a, and the upper placement frame 5a is arranged above the barbecue grill 6a at an interval. The barbecue grill 6a is configured to barbecue food, and the upper placement frame 5a is configured to place barbecued food or to-be-barbecued food in some embodiments. When the barbecue oven 200 is in the second state, the upper placement frame 5a is detachably suspended from the cover 2a or detachably arranged on the barbecue grill 6a in some embodiments, to maintain a temperature of the barbecued food.

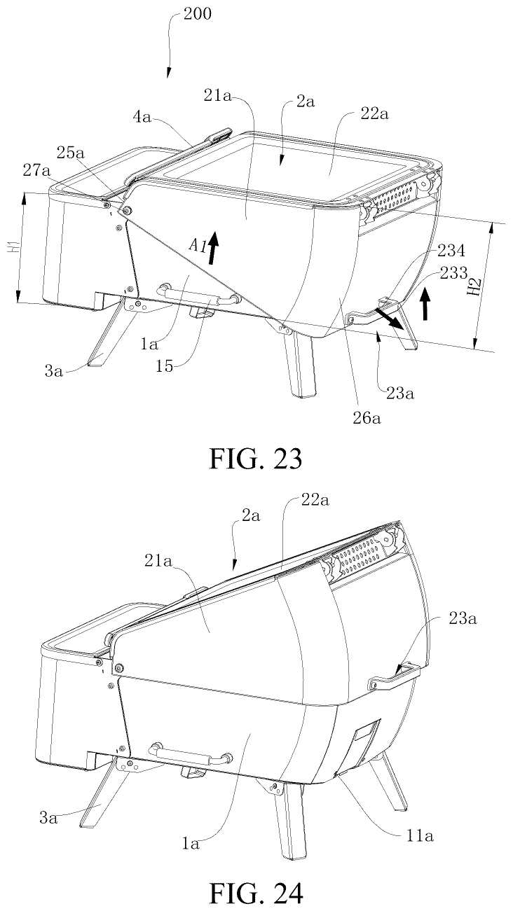

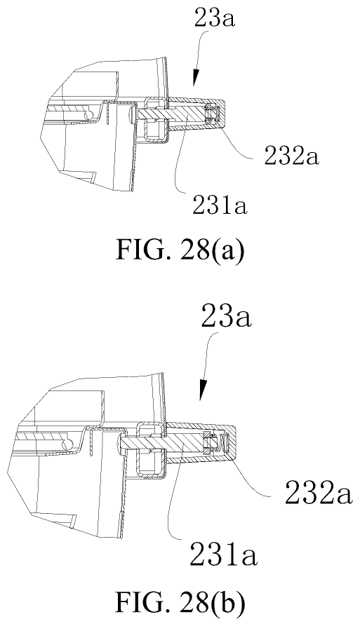

In some embodiments, referring to FIG. 23, FIG. 28(a), and FIG. 28(b), the first locking mechanism 23a includes a first locking member 231a and a first elastic member 232a. A holding portion 233 and a pressing portion 234 arranged on the holding portion 233 are arranged on the end plate 210. When the holding portion 233 on the end plate 210 is held, the pressing portion 234 can be simultaneously pressed. Because the pressing portion 234 is connected to the first locking member 231a, the operation can be performed by using one hand. The first locking member 231a is unlocked by the pressing portion 234, so that the first locking member 231a is detached from the first locking hole 11a or the second locking hole (not shown due to blocking by the cover 2a), and the cover 2a can be rotated clockwise or counterclockwise, to implement transformation between the first state and the second state. When the pressing portion 234 is released, the first locking member 231a is reset to the locking hole under action of the first elastic member 232a, to fix the cover 2a in the first position and/or the second position.

In some embodiments, two first locking members 231a are provided and respectively located on two sides of the pressing portion 234, and two first elastic members 232a are provided and respectively located on the two sides of the pressing portion 234, so that the cover 2a is stably maintained at a specific position when the cover 2a is in the first position or the second position.

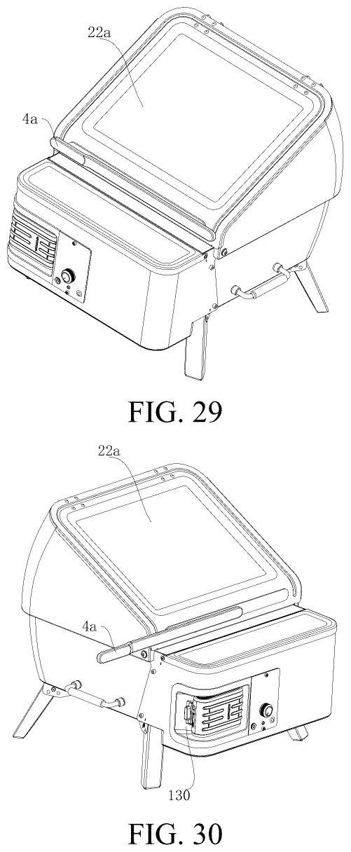

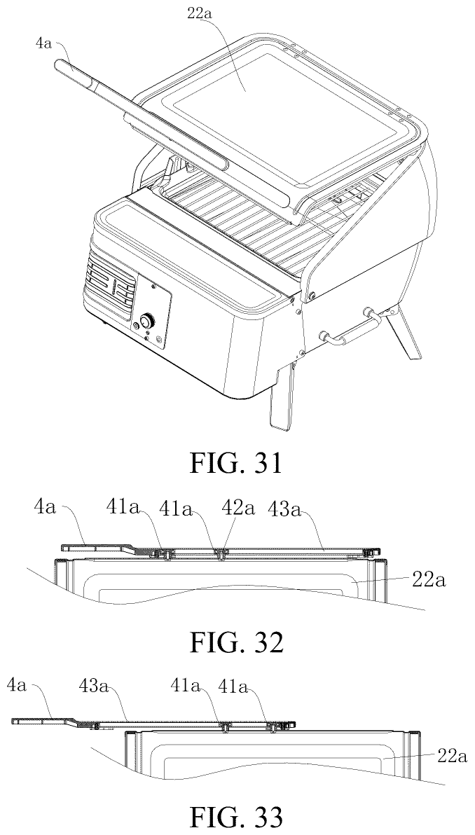

In some embodiments, as shown in FIG. 29 to FIG. 33, the hood body 22a includes a first end and a second end opposite to the first end. The first end is configured to be rotatably mounted on the housing body 21a. A handle 4a is arranged at the second end. The handle 4a has an empty groove 43a. A bearing 41a and a bearing 42a are arranged on the hood body 22a. The handle 4a can move relative to the hood body 22a in a direction away from the oven body 1a. When the handle 4a moves away from the oven body 1a, the handle 4a can be held, to rotate the hood body 22a to open and close the cooking cavity. In other embodiments, the cooking cavity is opened and closed by sliding the hood body 22a relative to the housing body 21a or performing a rotation operation on the handle 4a. In this way, a better hand feel is achieved, and a better anti-scald effect is achieved, thereby protecting the user from being hurt by high temperature.

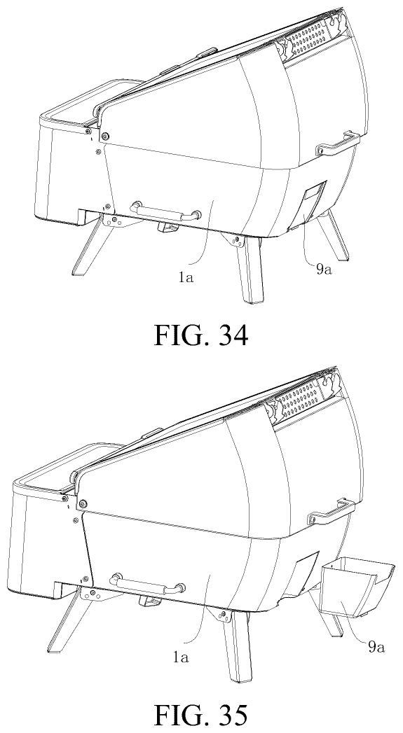

In some embodiments, FIG. 34 and FIG. 35 show a position of the grease drip collection box 9a when the cover 2a is unfolded from the first position to the second position. The grease drip collection box 9a is movably arranged on the oven body 1a. When the barbecue oven is in the second state, the grease drip collection box 9a is hiddenly mounted on the oven body 1a. In this case, when viewed in a direction along the rotation axis of the rotation shaft 27a, an outer contour surface of the grease drip collection box 9a coincides with the outer contour 110 of the oven body 1a, so that the barbecue oven is overall aesthetically pleasant, has no angular position, and is easy to clean.

In some embodiments, as shown in FIG. 23, the barbecue oven 200 further includes a grip 15. In some embodiments, two grips 15 are provided, and respectively arranged on two side surfaces of the oven body, to facilitate carrying and moving the barbecue oven.

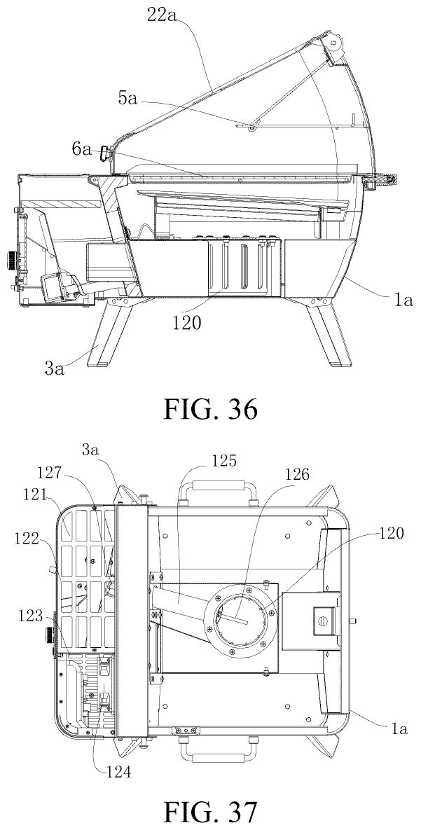

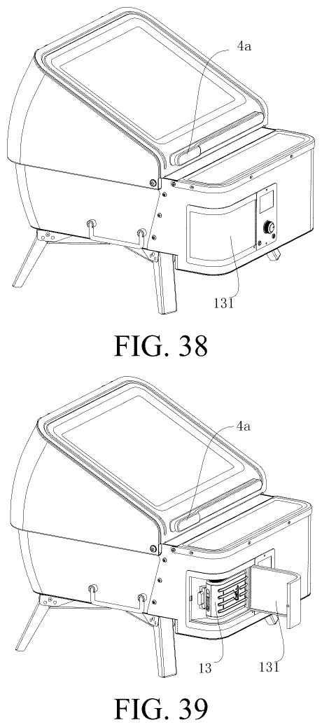

In some embodiments, as shown in FIG. 27, FIG. 36, and FIG. 37, the barbecue oven 200 further includes a combustion chamber, a firepot 120, a hopper 121, a auger 127, a fan 124, a battery pack 13, and the like. The firepot 120 is arranged in the oven body 1a, and the combustion chamber is configured to burn pellet fuel in the firepot 120, to provide heat or smoke for the second chamber. The hopper 121 is configured to provide storage space for the pellet fuel, and a protective net 122 is arranged above the hopper 121, to prevent safety problems caused by the user contacting an interior of the hopper. The auger 127 is arranged in a feeding pipe 125, and is located between the hopper 121 and the combustion chamber. An igniter 126 is further arranged in the feeding pipe 125. The igniter 126 extends into the firepot 120, and is configured to ignite the pellet fuel. The auger 127 is configured to selectively convey the pellet fuel from the hopper 121 to the combustion chamber for burning. The fan 124 blows air into the combustion chamber or allows oxygen to enter the combustion chamber by taking air from an air inlet 123 on the oven body 1a. The battery pack 13 is configured to provide power for at least one of the auger 127, the fan 124, and the igniter 126. In the first state and/or the second state, at least one of the hopper 121, the fan 124, and the battery pack 13 is located outside the second chamber and the combustion chamber. In other possible embodiments, at least one of the auger 127, the fan 124, and the igniter 126 is powered by alternating-current electricity or an in-vehicle power supply.

At least one of the hopper 121, the fan 124, and the battery pack 13 is located outside the second chamber and the combustion chamber, and specifically, is arranged on a front side or a left side (defined from an operating perspective of a user that is barbecuing) of the barbecue oven in some embodiments. In this way, the hopper 121, the fan 124, and the battery pack 13 do not occupy space of the cooking chamber, thereby achieving high space utilization. In addition, a space above the hopper 121 and the fan 124 can be further used for placing food or barbecue equipment, and the heat in the cooking chamber does not affect the pellet fuel stored in the hopper 121, so that the overall barbecue oven is more compact, has a proper structure, and is convenient to use.

In some embodiments, a temperature sensor 10 is further arranged in the barbecue oven 200. The temperature sensor 10 is located in the cooking cavity, and is configured to detect a temperature in the cooking cavity, to control operation of the auger 127, the fan 124, and the like. A cover plate 17a is further arranged above the protective net 122 and the fan 124. The cover plate 17a is movably arranged relative to the oven body 1a, and is switchable between an open position and a closed position. When the cover plate 17a is opened, the pellet fuel can be placed into the hopper 121 through the protective net 122. The cover plate 17a is an integral piece in some embodiments. As shown in FIG. 27, opening the cover plate 17a can expose the protective net 122 and the fan 124.

A control board (not shown) is further arranged in the oven body 1a. The control board is connected to the battery pack 13, a feed motor of the auger 127, the fan 124, the igniter 126, the temperature sensor 10, and the like. An operation button 16 is further arranged on an outer side of the oven body 1a close to the hopper 121. The temperature in the cooking chamber can be controlled through the control board by rotating or pressing the operation button 16, to implement different barbecue modes for different foods.

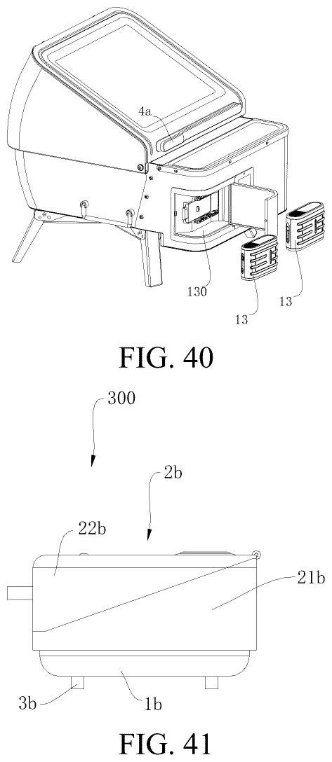

In some embodiments, as shown in FIG. 39 and FIG. 40, an outer peripheral wall of the oven body 1a includes a groove 130, and the battery pack 13 is at least partially arranged in the groove 130. In some embodiments, the battery pack 13 does not protrude from the groove 130.

In some embodiments, the barbecue oven 200 oven further includes a battery compartment cover 131, where the battery compartment cover 131 operably moves relative to the oven body 1a to cover or uncover the battery pack 13. In some embodiments, when the battery compartment cover covers the battery pack, the battery compartment cover is flush with the outer peripheral wall of the oven body. In this way, the battery pack is clean and tidy, the barbecue oven is overall aesthetically pleasant, and it is easy to clean grease stains on a surface of the barbecue oven.

In some embodiments, the groove 130 can further accommodate battery packs 13 of different sizes, so that the battery packs 13 of different capacities can be used to supply power to the barbecue oven.

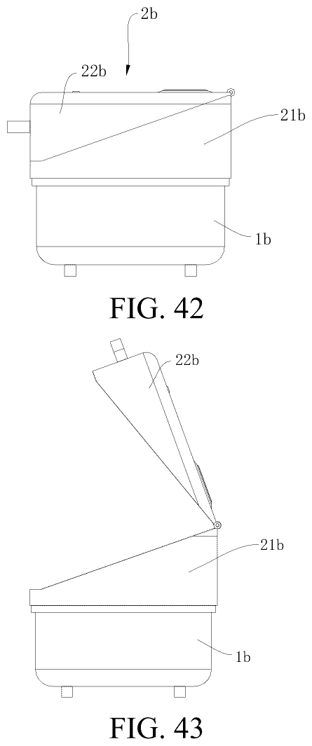

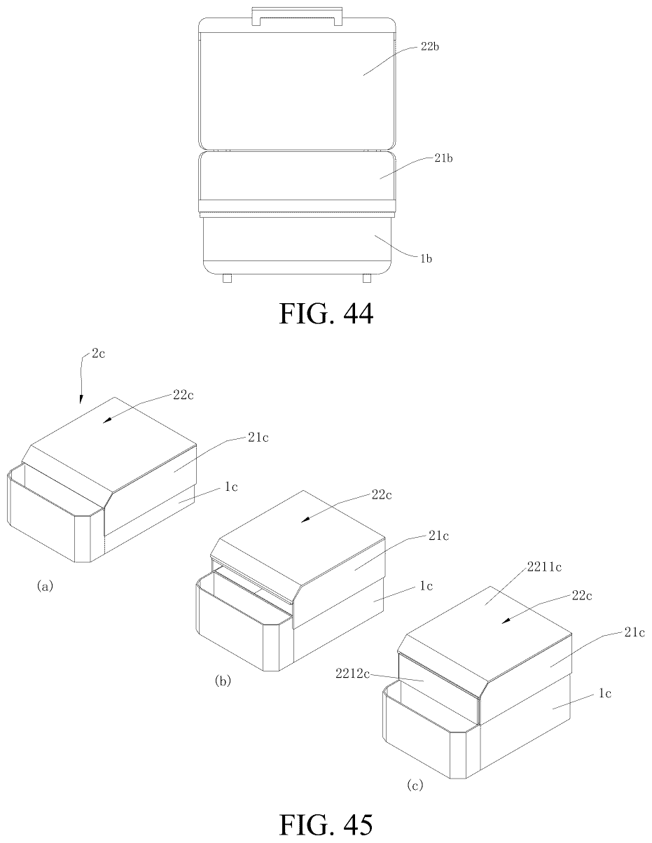

It should be noted herein that, in some other embodiments, a connection manner in which the cover is connected to the oven body is not limited to a rotatable connection manner, and is movable connection in some embodiments. That is, the cover is slidably connected to the oven body. For example, as shown in FIG. 41 to FIG. 44, a barbecue oven 300 includes an oven body 1b and a cover 2b. The cover 2b can be lifted and lowered relative to the oven body 1b to a first position and a second position, to form a first state and a second state of the barbecue oven 300 in which a barbecue grill is covered. In the first state (a state shown in FIG. 41), the barbecue oven 300 is in a non-use state. The cover 2b is lowered to be folded on the oven body 1b, and a plane on which a support surface is located and the cover 2b enclose a first chamber having a first volume. In the second state (a state shown in FIG. 42), the barbecue oven 300 is in a use state. The cover 2b is lifted relative to the oven body 1b, to form a cooking chamber, and the plane on which the support surface is located and the cover 2b enclose a second chamber having a second volume. The first volume is smaller than the second volume. In the first state, a volume of the barbecue oven 300 is reduced, facilitating storage and transportation.

The cover 2b includes a housing body 21b and a hood body 22b operably moving relative to the housing body 21b. The hood body 22b is configured to open and close the cooking cavity. During barbecue operation, the hood body 22b is used to open the cooking cavity, to form a third state of the barbecue oven in which the barbecue grill is at least partially exposed. In this case, to-be-cooked food can be placed, or barbecued food can be taken out.

The barbecue oven 300 further includes a support leg 3b. The support leg 3b is arranged below the oven body 1b, and is configured to support the oven body. In this embodiment, the support leg 3b is short, and consequently does not move relative to the oven body 1b alone for folding. In other embodiments, the support leg 3b is arranged based on an overall size and a height requirement of the barbecue oven, or a roller or the like is arranged under the support leg 3b, to facilitate transportation.

In some embodiments, the cover is slidably connected to the oven body. The cover wraps a part of the oven body, and the cover does not fully cover the oven body. For example, as shown in FIG. 45, the barbecue oven includes an oven body 1c and a cover 2c. The cover 2c can be lifted and lowered relative to the oven body 1c to a first state and a second state, to form a first state and a second state in which the barbecue grill is covered. A part of the oven body accommodating the hopper, the battery pack, and the fan is located outside the cover 2c. As shown in FIG. 45(a), in the first state, the barbecue oven is in the non-use state, and the plane on which the support surface is located and the cover 2c enclose a first chamber having a first volume. As shown in FIG. 45(c), in the second state, the barbecue oven is in the use state. The cover 2c is lifted relative to the oven body 1c, to form a cooking chamber, and the plane on which the support surface is located and the cover 2c enclose a second chamber having a second volume. The first volume is smaller than the second volume. As shown in FIG. 45(b), the barbecue oven is in an intermediate state between the first state and the second state, which is also one of use states, and is used for barbecuing food of a small volume. In other embodiments, the user adjusts a size of the cooking chamber based on a size of food, so that the cover 2c stops at a proper position for accommodating the to-be-barbecued food. In this way, the size of the barbecue oven is reduced, and the food can be fully barbecued, thereby reducing waste of heat.

The cover 2c includes a housing body 21c and a hood body 22c operably moving relative to the housing body 21c. The hood body 22c is configured to open and close the cooking cavity. The hood body 22c includes a first hood body 2211c and a second hood body 2212c movable relative to the first hood body 2211c. During barbecue operation, the hood body 22c is used to open the cooking cavity, to form a third state of the barbecue oven in which the barbecue grill is at least partially exposed. In this case, to-be-cooked food can be placed, or barbecued food can be taken out.

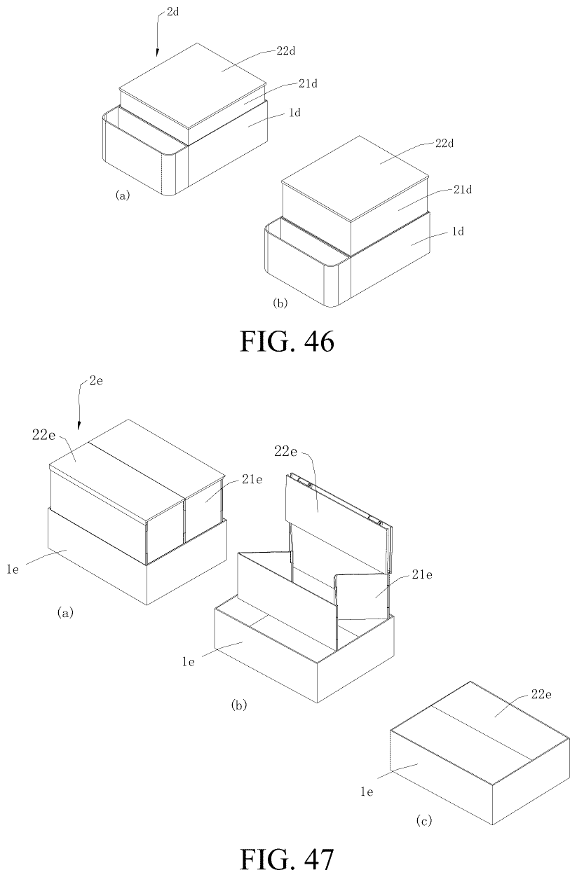

In some embodiments, the cover is slidably connected to the oven body. The oven body wraps a part of the cover, and the cover does not fully cover the oven body. For example, as shown in FIG. 46, the barbecue oven includes an oven body 1d and a cover 2d. The cover 2d can be lifted and lowered relative to the oven body 1d to a first state and a second state, to form a first state and a second state in which the barbecue grill is covered. A part of the oven body accommodating the hopper, the battery pack, and the fan is located outside the cover 2d. As shown in FIG. 46(a), in the first state, the barbecue oven is in the non-use state, and the plane on which the support surface is located and the cover 2d enclose a first chamber having a first volume. As shown in FIG. 46(c), in the second state, the barbecue oven is in the use state. The cover 2d is lifted relative to the oven body 1d, to form a cooking chamber, and the plane on which the support surface is located and the cover 2d enclose a second chamber having a second volume. The first volume is smaller than the second volume. The cover 2d includes a housing body 21d and a hood body 22d operably moving relative to the housing body 21d. The hood body 22d is configured to open and close the cooking cavity.

In some embodiments, the cover is movably connected to the oven body, and the cover is foldable. For example, as shown in FIG. 47, the barbecue oven includes an oven body 1e and a cover 2e. The cover 2e is movably arranged relative to the oven body 1e to a first state and a second state. As shown in FIG. 47(a), in the first state, the cover 2e can be folded on the oven body 1e, the barbecue oven is in the non-use state, and the plane on which the support surface is located and the cover 2e enclose a first chamber having a first volume. As shown in FIG. 47(a), in the second state, the barbecue oven is in the use state. The cover 2e can be unfolded relative to the oven body 1e, to form a cooking chamber, and the plane on which the support surface is located and the cover 2e enclose a second chamber having a second volume. The first volume is smaller than the second volume. FIG. 47(b) shows a state of the cover 2e in a folding process. The cover 2e is formed by a plurality of plates connected by hinges, so that the cover 2e is rotatable around the hinge to be folded. The cover 2e includes a housing body 21e and a hood body 22e operably moving relative to the housing body 21e. The hood body 22e is configured to open and close the cooking cavity.

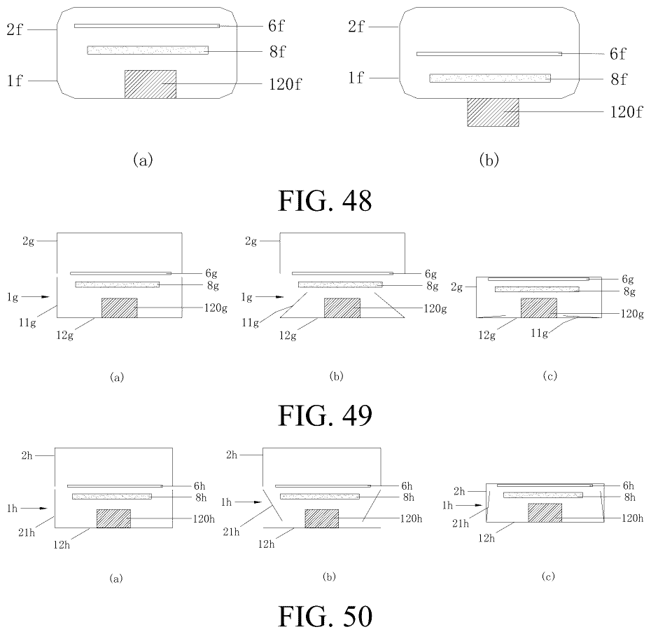

In some embodiments, as shown in FIG. 48, a cover 2f is movably connected to an oven body 1f. As shown in FIG. 48(a), in a first state, a barbecue grill 6f, a fire blocking plate or a grease drip pan 8f, and a firepot 120f are placed in the oven body 1f in some embodiments. The barbecue oven is in the non-use state, and the plane on which the support surface is located and the cover 2f enclose a first chamber having a first volume. As shown in FIG. 48(b), in a second state, the barbecue oven is in the use state. The firepot 120f is placed below the oven body 1f, and the barbecue grill 6f, and the fire blocking plate or the grease drip pan 8f are lowered as a whole, to form a cooking chamber. The plane on which the support surface is located and the cover 2f enclose a second chamber having a second volume. The first volume is smaller than the second volume.

In some embodiments, as shown in FIG. 49, a cover 2g is movably connected to an oven body 1g, and a barbecue grill 6g, a fire blocking plate or a grease drip pan 8g, and a firepot 120g are placed in the oven body 1g. As shown in FIG. 49(c), in a first state, the barbecue oven is in the non-use state, and the plane on which the support surface is located and the cover 2g enclose a first chamber having a first volume. As shown in FIG. 49(c), in a second state, the barbecue oven is in the use state. The cover 2g is lifted relative to the oven body 1g, to form a cooking chamber, and the plane on which the support surface is located and the cover 2g enclose a second chamber having a second volume. The first volume is smaller than the second volume. As shown in FIG. 49(b), the oven body 1g includes a bottom surface 12g and a peripheral wall 11g. The peripheral wall 11g is foldable relative to the bottom surface 12g. In this case, the barbecue oven is folded from the second state to the first state.

In some embodiments, as shown in FIG. 50, a cover 2h is movably connected to an oven body 1h. As shown in FIG. 50(a), in a first state, the barbecue oven is in the non-use state, and the plane on which the support surface is located and the cover 2h enclose a first chamber having a first volume. A barbecue grill 6h, a fire blocking plate or a grease drip pan 8h, and a firepot 120h are placed in the cover 2h. As shown in FIG. 50(c), in a second state, the barbecue oven is in the use state. The cover 2h is lifted relative to the oven body 1h, to form a cooking chamber, and the plane on which the support surface is located and the cover 2h enclose a second chamber having a second volume. The first volume is smaller than the second volume. As shown in FIG. 50(b), the oven body 1h includes a bottom surface 12h, the cover 2h includes a peripheral wall 21h, and the peripheral wall 21h is foldable. In this case, after the peripheral wall 21h is folded, the cover 2h moves downward as a whole, and the barbecue oven is folded from the second state to the first state.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

The foregoing embodiments only describe several embodiments of this application, which are described specifically and in detail, but cannot be construed as a limitation to the patent scope of the present disclosure. It should be noted that for a person of ordinary skill in the art, several transformations and improvements can be made without departing from the idea of the present disclosure. These transformations and improvements belong to the protection scope of this application.

What is claimed is:

1. A barbecue oven comprising:
a barbecue grill configured for placing to-be-cooked food;
an oven body comprising a support surface for supporting the barbecue grill; and
a cover,
wherein:
the cover and the oven body arranged movably relative to each other, to form a first state and a second state of the barbecue oven;
in the first state, a first chamber is enclosed by a plane on which the support surface is located and the cover, the first chamber having a first volume; and
in the second state, a second chamber is enclosed by a plane on which the support surface is located and the cover, the second chamber having a second volume, the first volume being less than the second volume.

2. The barbecue oven according to claim 1, wherein the first volume is defined as V1, the second volume is defined as V2, and a value of V2/V1 is in a range of 2.4 to 4.8.

3. The barbecue oven according to claim 1, wherein:
a projection area of the barbecue grill on the plane on which the support surface is located is defined as S1; and
in the first state, a projection area of the barbecue oven on the plane on which the support surface is located is defined as S2, and a value of S1/S2 is in a range of 0.53 to 0.8.

4. The barbecue oven according to claim 1, wherein a height of the oven body is defined as H1, a height of the barbecue oven in the first state is defined as H2, and a value of H2/H1 is in a range of 1.06 to 1.83.

5. The barbecue oven according to claim 1, wherein:
the cover operably moves relative to the oven body; and
in the first state, the cover covers at least a part of an outer contour of the oven body, and in the second state, the cover is unfolded relative to the oven body.

6. The barbecue oven according to claim 1, wherein:
the cover has a first side and a second side opposite to the first side; and
the cover is rotatably connected to the oven body on the first side by a rotation shaft.

7. The barbecue oven according to claim 6, wherein in a direction perpendicular to the plane on which the support surface is located, a length of the second side is greater than a length of the first side.

8. The barbecue oven according to claim 6, wherein:
the rotation shaft has a rotation axis;
an outer contour of the cover comprises a first arc with the rotation axis as a center when viewed in a direction along the rotation axis; and
an outer contour of the oven body comprises a second arc whose center is close to or coinciding with the rotation axis when viewed in the direction along the rotation axis.

9. The barbecue oven according to claim 1, wherein the cover is slidably connected to the oven body.

10. The barbecue oven according to claim 1, wherein the barbecue oven further comprises a first locking mechanism, configured to maintain the cover in the second state when the cover moves to the second state.

11. The barbecue oven according to claim 10, wherein:
the first locking mechanism comprises a first locking member movably arranged on the cover; and
when the barbecue oven is in the second state, the first locking member is inserted into a second locking hole provided on the oven body.

12. The barbecue oven according to claim 10, wherein the first locking mechanism is configured to maintain the cover in the first state when the cover moves to the first state.

13. The barbecue oven according to claim 1, wherein:
the cover comprises a housing body and a hood body operably moving relative to the housing body; and
the hood body is openable to form a third state of the barbecue oven in which at least a part of the barbecue grill is exposed.

14. The barbecue oven according to claim 13, wherein the hood body is rotatably connected to the housing body.

15. The barbecue oven according to claim 13, wherein the hood body comprises a first end and a second end opposite to the first end,
wherein:
the first end is configured to be rotatably mounted on the housing body;
a handle is arranged at the second end; and
the handle is movable relative to the hood body in a direction away from the oven body.

16. The barbecue oven according to claim 1, further comprising an upper placement frame for placing food,
wherein:
the upper placement frame is arranged above the barbecue grill; and/or
the upper placement frame comprises a main frame and a support arm rotatably connected to the main frame, wherein the support arm is detachably suspended from the cover.

17. The barbecue oven according to claim 1, further comprising:
a support frame, wherein the support frame comprises a guide portion, and the barbecue grill is supported on the support surface by the guide portion; and
a grease drip pan, arranged below the barbecue grill,
wherein the guide portion is configured to guide grease dripping from an edge of the barbecue grill to the grease drip pan.

18. The barbecue oven according to claim 1, further comprising:
a combustion chamber configured for burning pellet fuel, to provide heat and/or smoke for the second chamber;
a hopper configured to provide storage space for the pellet fuel;
an auger interposing the hopper and the combustion chamber, and configured to selectively convey the pellet fuel from the hopper to the combustion chamber for combustion;
a fan configured to blow air into the combustion chamber or allow oxygen to enter the combustion chamber; and
a battery pack configured to provide power for the auger and/or the fan,
wherein in the first state and/or the second state, at least one of the hopper, the fan, and the battery pack is located outside the second chamber and the combustion chamber.

19. The barbecue oven according to claim 18, wherein an outer peripheral wall of the oven body comprises a groove, and the battery pack is at least partially arranged in the groove, and the battery pack does not protrude from the groove.

20. The barbecue oven according to claim 1, further comprising a support leg, wherein the support leg operably moves relative to the oven body, to support the oven body or to be folded on the oven body.
